(19) United States
(12) Patent Application Publication
(10) Pub. No.: US 2005/0092620 A1
(43) Pub. Date: May 5, 2005

(54) Methods and apparatus for polishing a substrate

(75) Inventors: Rashid A. Mavliev, Campbell, CA (US); Alain Duboust, Sunnyvale, CA (US); Stan D. Tsai, Fremont, CA (US)

Correspondence Address: Applied Materials;Patent Counsel, Legal Affairs Department, P.O. Box 450A, Santa Clara, CA, 95052, US

(73) Assignee: APPLIED MATERIALS, INC.

(21) Appl. No.: 10/957,199

(22) Filed: Oct. 1, 2004

Related U.S. Application Data
(60) Provisional application No. 60/507,611, filed on Oct. 1, 2003.

(51) Int. Cl. B23H 3/00

(52) U.S. Cl. 205/662

(57) ABSTRACT

Polishing compositions and methods for removing conductive material and barrier layer materials from a substrate surface are provided. Generally, variable amounts of abrasive particles are used for removing conductive material and barrier layer materials. In one aspect, a process is provided including providing an polishing composition between the first electrode and the substrate, wherein the polishing composition comprises a first concentration of abrasive particles, applying a bias between the first electrode and the second electrode, providing relative motion between the substrate and the polishing article, removing conductive layer material from the substrate, introducing abrasive particles to the polishing composition to form a second concentration of abrasive particles greater than a first concentration of abrasive particles, and removing barrier layer material from the substrate. The abrasive particles may be incrementally introduced or pulsed during a polishing process.

### CROSS-REFERENCE TO RELATED APPLICATIONS

This application claims benefit of U.S. provisional patent application Ser. No. 60/507,611, filed Oct. 1, 2003, which is herein incorporated by reference.

### BACKGROUND OF THE INVENTION

1. Field of the Invention

Embodiments of the present invention relate to compositions and methods for removing conductive materials from a substrate.

2. Background of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process in which material is removed from the surface of the substrate to form a generally even, planar surface. Planarization is useful in removing excess deposited material, removing undesired surface topography, and surface defects, such as surface roughness, agglomerated materials, crystal lattice damage, scratches, and contaminated layers or materials to provide an even surface for subsequent photolithography and other semiconductor manufacturing processes.

Electrochemical mechanical polishing (ECMP) is one method of planarizing a surface of a substrate. ECMP removes conductive materials, such as copper, from a substrate surface by electrochemical “anodic” dissolution while polishing the substrate with a reduced mechanical abrasion compared to conventional chemical mechanical planarization (CMP) processes. A typical ECMP system includes a substrate support and two electrodes disposed within an electrolyte containment basin. The substrate is in electrical contact with one of the electrodes, and in effect during processing, the substrate becomes an electrode for material removal. During anodic dissolution, metal atoms on a surface of a substrate are ionized by an electrical current from a source of potential, such as a voltage source connected to the two electrodes. The metal ions dissolve into the surrounding polishing composition.

Conventional ECMP processes have been observed to have less than satisfactory barrier removal rates and often leave behind barrier material residue on a substrate surface. Conductive barrier material residues may provide conductive paths between otherwise isolated copper features, referred to as residual conductivity, and if in contact with a power source, detrimentally result in excess removal of copper material from features by anodic dissolution. Extending polishing processes to remove barrier residues has also been observed to result in excess removal of copper from features.

Excess copper removal from features may result in the formation of topographical defects, such as concavities or depressions, referred to as dishing. Dishing results in a non-planar surface that detrimentally affect subsequent substrate processing, such as impairing the ability to print high recomposition lines during subsequent photolithographic steps, and further detrimentally affects subsequent surface topography of the substrate and device formation. Dishing has also bee observed to detrimentally affect the performance of devices by lowering the conductance and increasing the resistance of the devices, contrary to the benefit of using higher conductive materials, such as copper.

Therefore, there is a need for compositions and methods for removing conductive barrier material from a substrate with reduced topographical defects during planarization.

### SUMMARY OF THE INVENTION

Aspects of the invention provide compositions and methods for removing conductive materials by an electrochemical polishing technique. In one aspect, a method is provided for processing a substrate having a barrier material layer and a conductive material layer formed on the barrier material layer including disposing a substrate in an apparatus comprising a first electrode and a second electrode, wherein the substrate is in electrical contact with the second electrode, providing an polishing composition between the first electrode and the substrate, wherein the polishing composition comprises a first concentration of abrasive particles, applying a bias between the first electrode and the second electrode, providing relative motion between the substrate and the polishing article, removing conductive material layer from the substrate, introducing abrasive particles to the polishing composition to form a second concentration of abrasive particles greater than a first concentration of abrasive particles, and removing at least a portion of the barrier material layer from the substrate.

In another aspect, a method is provided for processing a substrate having a barrier material layer and a conductive material layer formed on the barrier material layer including polishing a substrate by a first electrochemical mechanical polishing process having a first composition with a first abrasive particle concentration to remove a portion of the conductive material layer and polishing a substrate by a second electrochemical mechanical polishing process having a second composition with a second abrasive particle concentration greater than the first abrasive particle concentration to remove a second portion of the conductive material layer and at least a portion of the barrier material layer.

In another aspect, a method is provided for processing a substrate having a barrier layer and a conductive material layer formed on the barrier layer including disposing a substrate in an apparatus comprising a first electrode and a second electrode, wherein the substrate is in electrical contact with the second electrode, providing an polishing composition between the first electrode and the substrate, applying a bias between the first electrode and the second electrode, providing relative motion between the substrate and the polishing article, pulsing the amount of abrasive in the composition, and removing conductive layer material and barrier layer material from the substrate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a plan view of one embodiment of a processing apparatus of the invention;

FIG. 2 is a cross-sectional view of one embodiment of a polishing process station;

FIG. 3 is a flow chart of one embodiment of an electrochemical mechanical polishing process;

FIG. 4 is a flow chart of another embodiment of an electrochemical mechanical polishing process.

### DETAILED DESCRIPTION OF THE PREFERRED EMBODIMENT

In general, aspects of the invention provide compositions and methods for removing a conductive material from a substrate surface. The invention is described below in reference to a planarizing process for the removal of conductive materials from a substrate surface by an electrochemical mechanical polishing (ECMP) technique.

The words and phrases used herein should be given their ordinary and customary meaning in the art by one skilled in the art unless otherwise further defined. Chemical polishing should be broadly construed and includes, but is not limited to, planarizing a substrate surface using chemical activity. Chemical mechanical polishing should be broadly construed and includes, but is not limited to, planarizing a substrate surface using chemical activity and mechanical activity. Electropolishing should be broadly construed and includes, but is not limited to, planarizing a substrate by the application of electrochemical activity. Electrochemical mechanical polishing (ECMP) should be broadly construed and includes, but is not limited to, planarizing a substrate by the application of electrochemical activity, mechanical activity, chemical activity, or a combination of electrochemical, chemical, and mechanical activity to remove material from a substrate surface.

Anodic dissolution should be broadly construed and includes, but is not limited to, the application of an anodic bias to a substrate directly or indirectly which results in the removal of conductive material from a substrate surface and into a surrounding polishing composition. Polishing composition should be broadly construed and includes, but is not limited to, a composition that provides ionic conductivity, and thus, electrical conductivity, in a liquid medium, which generally comprises materials known as electrolyte components. The amount of each electrolyte component in polishing compositions can be measured in volume percent or weight percent. Volume percent refers to a percentage based on volume of a desired liquid component divided by the total volume of all of the liquid in the complete composition. A percentage based on weight percent is the weight of the desired component divided by the total weight of all of the liquid components in the complete composition.

An Apparatus Embodiment

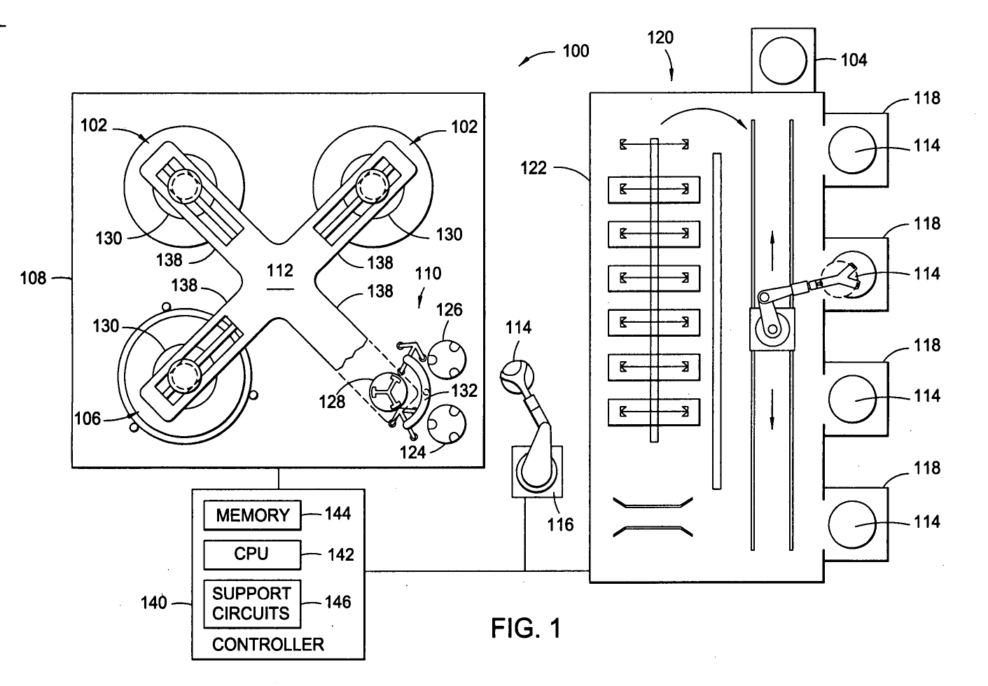

FIG. 1 depicts one embodiment of an electrochemical processing apparatus suitable for performing the processes described herein. The electrochemical processing apparatus 100 has at least one electrochemical mechanical polishing (ECMP) station 102, and optionally, the system 100 may include at least one conventional polishing station 106 disposed adjacent the ECMP station 102 on a single platform or tool. One polishing tool that may be adapted to benefit from the invention is a REFLEXION® chemical mechanical polisher available from Applied Materials, Inc. located in Santa Clara, Calif. Examples of other polishing tools that may be adapted to benefit from the invention are the MIRRA® chemical mechanical polisher and the MIRRA MESA™ chemical mechanical polishers also available from Applied Materials, Inc.

The exemplary apparatus 100 generally includes a base 108 that supports the one or more ECMP stations 102, the one or more polishing stations 106, a transfer station 110, and a carousel 112. A loading robot 116 generally facilitates transfer of substrates 114 to and from the transfer station 110 of the apparatus 100 and a factory interface 120. The factory interface 120 may include a cleaning module 122, a metrology device 104, and one or more substrate storage cassettes 118. One example of a metrology device 104 that may be utilized in the factory interface 120 is a NovaScan™ Integrated Thickness Monitoring system, available from Nova Measuring Instruments, Inc., located in Phoenix, Ariz.

In one embodiment, the transfer station 110 includes an input buffer station 124, an output buffer station 126, a transfer robot 132, and a load cup assembly 128. The input buffer station 124 accepts substrates from the factory interface 120 by the loading robot 116. The loading robot 116 is also utilized to return polished substrates from the output buffer station 126 to the factory interface 120. The transfer robot 132 is utilized to move substrates between the buffer stations 124, 126 and the load cup assembly 128.

In one embodiment, the transfer robot 128 includes two gripper assemblies, each having pneumatic gripper fingers that hold the substrate 114 by the substrate's edge. The transfer robot 132 may simultaneously transfer a substrate to be processed from the input buffer station 124 to the load cup assembly 128 while transferring a processed substrate from the load cup assembly 128 to the output buffer station 126.

The carousel 112 has a plurality of arms 138, each respectively supporting one of a plurality of polishing heads 130. Each polishing head 130 retains one substrate 114 during processing. Substrates are loaded and unloaded from the polishing heads 130 by the load cup assembly 128. One of the arms 138 depicted in FIG. 1 is not shown so that the transfer station 110 may be seen. The carousel 112 moves the polishing heads 130 between the load cup assembly 128 of the transfer station 110, the one or more ECMP stations 102 and the one or more polishing stations 106. One carousel 112 that may be adapted to benefit from the invention is generally described in U.S. Pat. No. 5,804,507, issued Sep. 8, 1998 to Tolles et al., which is hereby incorporated by reference in its entirety. It is contemplated that other transfer mechanisms may be utilized to move substrates between the stations 102, 104 and the transfer station 110.

The polishing head 130 retains the substrate 114 against the ECMP station 102 or polishing station 106 during processing. Examples of embodiments of polishing heads 130 that may be adapted to benefit from the invention are described in U.S. Pat. No. 6,183,354, issued Feb. 6, 2001 to Zuniga, et al. Other polishing heads that may be adapted benefit from the invention include TITAN HEAD™ and TITAN PROFILER™ wafer carriers, available from Applied Materials, Inc. The arrangement of the ECMP stations 102 and polishing stations 106 on the apparatus 100 allows for the substrate 114 to be sequentially polished by moving the substrate between stations while-being retained in the same polishing head 130. Alternatively, substrates may be polished in other sequences.

To facilitate control of the polishing apparatus 100 and processes performed thereon, a controller 140 comprising a central processing unit (CPU) 142, memory 144, and support circuits 146 is connected to the polishing apparatus 100. The CPU 142 may be one of any form of computer processor that can be used in an industrial setting for controlling various drives and pressures. The memory 144 is connected to the CPU 142. The memory 144, or computer-readable medium, may be one or more of readily available memories such as random access memory (RAM), read only memory (ROM), floppy disk, hard disk, or any other form of digital storage, local or remote. The support circuits 146 are connected to the CPU 142 for supporting the processor in a conventional manner. These circuits include cache, power supplies, clock circuits, input/output circuitry, subsystems, and the like.

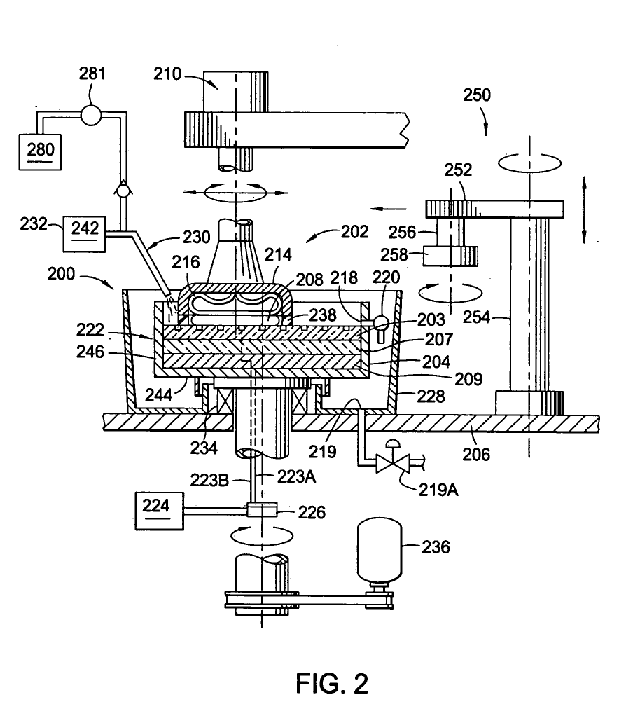

FIG. 2 depicts one embodiment of the ECMP station 102 as a cross-sectional view of one embodiment of a “face-down” process cell 200. The process cell 200 generally includes a basin 204 and a polishing head 202. A substrate 208 is retained in the polishing head 202 and lowered into the basin 204 during processing in a face-down (e.g., backside up) orientation. An electrolyte, such as described herein, flows into the basin 204 and is in contact with the substrate's surface and a polishing article assembly 222, while the polishing head 202 places the substrate 208 in contact with the polishing article assembly 222. The basin 204 includes the polishing article assembly 222, a bottom 244 and sidewalls 246 that define a container that houses the polishing article assembly 222. The sidewalls 246 include a port 218 formed therethrough to allow removal of polishing composition from the basin 204. The port 218 is coupled to a valve 220 to selectively drain or retain the polishing composition in the basin 204.

The substrate 208 and the polishing article assembly 222 disposed in the basin 204 are moved relative to each other to provide a polishing motion (or motion that enhances plating uniformity). The polishing motion generally comprises at least one motion defined by an orbital, rotary, linear or curvilinear motion, or combinations thereof, among other motions. The polishing motion may be achieved by moving either or both of the polishing head 202 and/or the basin 204. The polishing head 202 may be stationary or driven to provide at least a portion of the relative motion between the basin 204 and the substrate 208 held by the polishing head 202. In the embodiment depicted in FIG. 2, the polishing head 202 is coupled to a drive system 210. The drive system 210 can generally move the polishing head 202 with at least a rotary, orbital, sweep motion, or combinations thereof.

The polishing head 202 generally retains the substrate 208 during processing. In one embodiment, the polishing head 202 includes a housing 214 enclosing a bladder 216. The bladder 216 may be deflated when contacting the substrate to create a vacuum therebetween, thus securing the substrate to the polishing head 202 to allow placement and removal of the substrate. The bladder 216 may additionally be inflated and pressurized to bias and assure contact between the substrate and the polishing article assembly 222 retained in the basin 204. A retaining ring 238 is coupled to the housing 214 and circumscribes the substrate 208 to prevent the substrate from slipping out from the polishing head 202 while processing. One polishing head that may be adapted to benefit from the invention is a TITAN HEAD™ carrier head available from Applied Materials, Inc., located in Santa Clara, Calif. Another example of a polishing head that may be adapted to benefit from the invention is described in U.S. Pat. No. 6,159,079, issued Dec. 12, 2001, which is hereby incorporated herein by reference in its entirety.

The basin 204 is generally fabricated from a plastic such as fluoropolymers, TEFLON® polymers, perfluoroalkoxy resin (PFA), polyethylene-based plastics (PE), polyphenylether sulfones (PES), or other materials that are compatible or non-reactive with the polishing composition or other chemicals used in the processing cell 200. The basin 204 is rotationally supported above a base 206 by bearings 234. A drive system 236 is coupled to the basin 204 and rotates the basin 204 during processing. A catch basin 228 is disposed on the base 206 and circumscribes the basin 204 to collect processing fluids, such as a polishing composition, that flow out of port 218 disposed through the basin 204 during and/or after processing. An outlet drain 219 and outlet valve 219A are incorporated in the invention to allow the polishing composition in the catch basin to be sent to a reclaim system (not shown) or a waste drain (not shown).

In one embodiment the basin 204 is rotated at a velocity from about 3 to about 100 rpm, and the polishing head 202 is rotated at a velocity from about 5 to about 200 rpm and also moved linearly at a velocity of about 5 to about 25 centimeters per second in a direction radial to the basin 204. The preferred ranges for a 200 mm diameter substrate are a basin 204 rotational velocity of about 5 to about 40 rpm and a polishing head 202 rotational velocity of about 7 to about 100 rpm and a linear (e.g., radial) velocity of about 10 centimeters per second. The preferred ranges for a 300 mm diameter substrate are a basin 204 rotational velocity of about 5 to about 20 rpm and a polishing head 202 rotational velocity of about 7 to about 50 rpm and a linear (e.g., radial) velocity of about 10 centimeters per second. In one embodiment of the present invention the basin 204 has a diameter between about 17 inches and about 30 inches. The polishing head 202 may move along the radius of the basin 204 for a distance between about 0.1 inches and about 2 inches.

A polishing composition delivery system 232 is generally disposed adjacent the basin 204. The polishing composition delivery system 232 includes a nozzle or outlet 230 coupled to a polishing composition source 242. The outlet 230 delivers polishing composition or other processing fluids from the polishing composition source 242 into the basin 204. Additionally or alternatively, the polishing composition delivery system may provide polishing composition through an inlet (not shown) in the bottom 244 of the process cell, thus allowing polishing composition to flow through the polishing article assembly 222 to contact the conductive polishing article 203 and substrate 208. The polishing composition source 242 schematically shown here generally includes a source of all of the chemicals required to supply and support the polishing composition during processing. It is further contemplated in one embodiment of the current design to continually recirculate the polishing composition through the polishing article assembly 222 and across the surface of the substrate 208. In one embodiment the flow rate of polishing composition flowing through the process cell 200 is between about 0.1 to about 2 liters per minute.

Optionally, and shown in FIG. 2, a conditioning device 250 may be provided proximate the basin 204 to periodically condition or regenerate the polishing article assembly 222. Typically, the conditioning device 250 includes an arm 252 coupled to a stanchion 254 that is adapted to position and sweep a conditioning element 258 across polishing article assembly 222. The conditioning element 258 is coupled to the arm 252 by a shaft 256 to allow clearance between the arm 252 and sidewalls 246 of the basin 204 while the conditioning element 258 is in contact the polishing article assembly 222. The conditioning element 258 is typically a diamond or silicon carbide disk, which may be patterned to enhance working the surface of the polishing article assembly 222 into a predetermined surface condition/state that enhances process uniformity. Additionally or alternatively, the conditioning element 258 can be made of a Nylon™ brush or similar conditioner for in-situ conditioning the conductive polishing article 203. One conditioning element 258 that may be adapted to benefit from the invention is described in U.S. patent application Ser. No. 09/676,280, filed Sep. 28, 2000 by Li et al., which is incorporated herein by reference to the extent not inconsistent with the claims aspects and description herein.

A power source 224 is coupled to the polishing article assembly 222 by electrical leads 223A, 223B. The power source 224 applies an electrical bias to the polishing article assembly 222 to drive an electrochemical process described below. The leads 223A, 223B are routed through a slip ring 226 disposed below the basin 204. The slip ring 226 facilitates continuous electrical connection between the power source 224 and electrodes (209 and 203) in the polishing article assembly 222 as the basin 204 rotates. The leads 223A, 223B may be wires, tapes or other conductors compatible with process fluids or having a covering or coating that protects the leads from the process fluids. Examples of materials that may be utilized in the leads 223A, 223B include copper, graphite, titanium, platinum, gold, and HASTELOY® among other materials which can have an insulating coating on its exterior surface. Coatings disposed around the leads may include polymers such as fluorocarbons, PVC, polyamide, and the like. The slip ring 226 can be purchased from such manufacturers as IDM Electronics LTD, Reading Berkshire, England, a division of Kaydon Corporation, Ann Arbor, Mich.

The polishing article assembly 222 generally includes a conductive polishing article 203 coupled to a backing 207, and an electrode 209. The backing 207 may also be coupled to an electrode 209. The conductive polishing article 203 and the backing 207 have a plurality of holes or pores formed therein to allow the polish composition to make contact with, and thus provide a conductive path between the substrate 208 and the electrode 209. A dielectric insert (not shown) may be disposed between the conductive polishing article 203 and the backing 207 or between the backing 207 and the electrode 209 to regulate the electrolyte flow through all or a portion of the conductive polishing article 203, by use of a plurality of holes or pores formed therein. The conductive polishing article 203 is used to apply a uniform bias to the substrate surface by use of a conductive surface that makes contact with the surface of the substrate. The use of a conductive polishing article is generally preferred over the use of a conventional substrate contacting means such as discrete or point contacts, but should not be considered limiting to the scope of the present invention. During the anodic dissolution process the electrode 209 is generally biased as a cathode and the conductive polishing article 203, and substrate, are biased as an anode through use of the power supply 224.

Examples of the conductive polishing article 203 are more fully disclosed in U.S. patent application Ser. No. 10/033,732, filed on Dec. 27, 2001, U.S. patent application Ser. No. 10/211,626, filed on Aug. 2, 2002, U.S. patent application Ser. No. 10/455,941, filed on Jun. 6, 2003, and U.S. patent application Ser. No. 10/455,895, filed on Jun. 6, 2003, which are incorporated by reference herein to the extent not inconsistent with the claimed aspects and disclosure herein. Examples of an embodiment of the conductive polishing article 203 utilizing conventional polishing material with discrete conductive contacts are more fully disclosed in the U.S. patent application Ser. No. 10/211,626, filed on Aug. 2, 2003, which is incorporated by reference herein to the extent not inconsistent with the claimed aspects and disclosure herein.

As the polishing article assembly 222 includes elements comprising both an anode and cathode of an electrochemical cell, both the anode and a cathode may be replaced simultaneously by simply removing a used polishing article assembly 222 from the basin 204 and inserting a new polishing article assembly 222 with fresh electrical and supporting components into the basin 204. The face-down polishing apparatus is more fully disclosed in U.S. patent application Ser. No. 10/151,538, filed May 16, 2002, entitled “Method and Apparatus for Substrate Polishing,” commonly assigned to Applied Materials Inc., of which paragraphs 25-81 are incorporated herein by reference to the extent not inconsistent with the claims aspects and description herein.

Typically, the conductive polishing article 203, the backing 207, optionally, the dielectric insert, and the electrode 209 are secured together to form a unitary body that facilitates removal and replacement of the polishing article assembly 222 from the basin 204. The conductive polishing article 203, the backing 207, optionally the dielectric insert, and/or the electrode 209 may be coupled by use of methods such as adhesive bonding, thermal bonding, sewing, binding, heat staking, riveting, by use of fasteners and clamping, among others.

The process cell 200 may be disposed on a polishing platform with one or more chemical mechanical polishing platens suitable for conductive material and/or barrier material removal. Such chemical mechanical polishing platens may contain fixed-abrasive or non-abrasive polishing articles and may use abrasive containing or abrasive-free polishing composition. Additionally the polishing articles for the polishing platens may be hard polishing articles, having a durometer or hardness of 50 or greater on a shore D Scale or soft polishing articles having a durometer or hardness of less than 50, typically 40 or less, on a shore D Scale.

For example, the polishing platform may be of a three platen variety, such as the Mirra® polishing system, the Mirra Mesa™ polishing system, and the Reflexion™ polishing system, that are commercially available from Applied Materials, Inc., of Santa Clara, Calif., with the process cell 200 disposed at a first platen position, a conventional chemical mechanical polishing platen with a hard or soft polishing pad on a second platen position, and a barrier removal platen on the third platen position. In another example, a first process cell 200 disposed at a first platen position, for example, ECMP station 102, for a first electrochemical mechanical polishing process, a second process cell 200 disposed at a second platen position, for example, ECMP station 102, for a second electrochemical mechanical polishing process, and a conventional chemical mechanical polishing platen with a hard or soft polishing pad on a third platen position, for example, polishing station 106. The third polishing station may also be an electrochemical mechanical polishing apparatus for barrier layer removal. However, any system enabling electrochemical mechanical polishing may be used to advantage.

Electrochemical Mechanical Process:

Generally, methods described herein provide for removing conductive material and barrier materials by electrochemical polishing techniques. The processes described herein are suitable for reducing or minimizing the residual conductivity of barrier materials by eliminating or minimizing conductive paths formed from barrier materials between otherwise isolated copper features, referred to as “breaking”. Breaking involves removing enough barrier materials and any remaining conductive residual material to electrically isolate conductive features from each other or from contact with electrical sources.

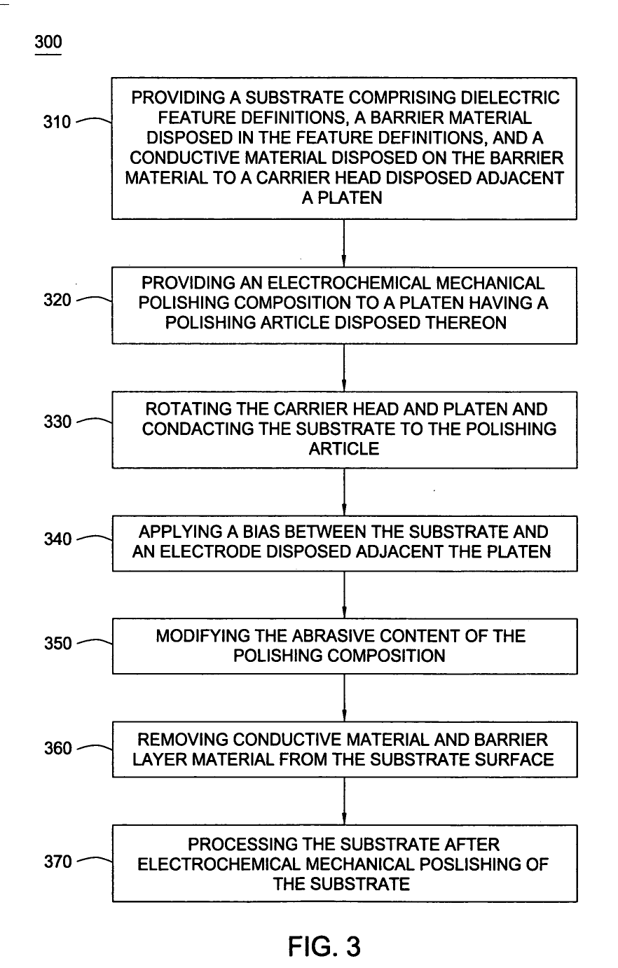

FIG. 3 is a flow chart of one embodiment of an electrochemical mechanical polishing process 300. A substrate is disposed in a carrier head as described herein and is provided to a polishing station, such as 200 described above, having a polishing article disposed on a platen at step 310. A composition having abrasive particles and etching composition is delivered to the processing station 200 to provide chemical and mechanical activity to any substrate exposed thereto at step 320. The substrate and platen are rotated and the substrate is contacted with the polishing article to provide mechanical abrasion of the substrate surface at step 330. A bias is applied between the substrate and an electrode disposed in the polishing station to provide anodic dissolution to the substrate surface at step 340. The abrasive content of the polishing composition is modified to provide selective polishing of the substrate surface at step 350. Conductive material and/or barrier material is removed from the substrate surface during steps 320 to 360. The substrate may then be further processed, for example, to remove any barrier material remaining, buffing any exposed dielectric material, cleaning the substrate, or post-treat to remove any surface defects, in step 370.

A substrate to be polished by the processes described herein may include, in one embodiment, conductive features formed in a dielectric material. A substrate generally includes a dielectric layer 310, which is patterned and etched to form a plurality of apertures or feature definitions, including vias, trenches, contacts, or holes. The apertures may be formed in the dielectric layer 310 by conventional photolithographic and etching techniques.

The dielectric layer may comprise one or more dielectric materials employed in the manufacture of semiconductor devices. For example, dielectric materials may include materials such as silicon dioxide, phosphorus-doped silicon glass (PSG), boron-phosphorus-doped silicon glass (BPSG), and silicon dioxide derived from tetraethyl orthosilicate (TEOS) or silane by plasma enhanced chemical vapor deposition (PECVD). The dielectric layer may also comprise low dielectric constant materials, including fluoro-silicon glass (FSG), polymers, such as polyamides, carbon-containing silicon oxides, such as Black Diamond™ dielectric material, silicon carbide materials, which may be doped with nitrogen and/or oxygen, including BLOk™ dielectric materials, available from Applied Materials, Inc. of Santa Clara, Calif.

A layer of barrier materials, a barrier layer, may then be disposed conformally in the feature definitions and on the field of the substrate. The barrier material may comprise any material that may limit diffusion of materials between the substrate and/or dielectric materials and any subsequently deposited conductive materials. For example, the barrier layer may comprise a metal material, such as tantalum, tantalum nitride, or combinations thereof, as a barrier layer material for a conductive material, such as copper. As used throughout this disclosure, the word “tantalum” and the symbol “Ta” are intended to encompass tantalum, tantalum nitride, and alloys, such as tantalum silicon nitride, or combinations thereof. Other types of barrier layers materials may include titanium, titanium nitride, titanium silicon nitrides, refractory metals, refractory metal nitrides, refractory metal silicides, refractory metal silicon nitrides, or combinations thereof, or any other material that may limit interlayer diffusion of materials. The barrier materials may be deposited, for example, by physical vapor deposition, chemical vapor deposition, or an atomic layer deposition process.

A conductive material layer is disposed on the barrier layer to fill the feature definition formed in the dielectric layer. The term “conductive material layer” as used herein is defined as any conductive material, such as copper, tungsten, or aluminum, used to fill a feature to form lines, contacts, or vias. While not shown, a seed layer of a conductive material may be deposited on the barrier layer prior to the deposition of the conductive material layer to improve interlayer adhesion and improve subsequent deposition processes. The seed layer may be of the same material as the subsequent material to be deposited.

One type of conductive material layer comprises copper containing materials. Copper containing materials include copper, copper alloys (e.g., copper-based alloys containing at least about 80 weight percent copper), or doped copper. As used throughout this disclosure, the phrase “copper containing material,” the word “copper,” and the symbol “Cu” are intended to encompass copper, copper alloys, doped copper, and combinations thereof. Additionally, the conductive material may comprise any conductive material used in semiconductor manufacturing processing.

A composition as described herein is supplied to the polishing station 200 for exposure to the substrate at step 320. Examples of polishing compositions are described herein. In processing, the polishing composition is supplied to the basin at a flow rate between about 50 ml/min and about 500 ml/min, for example, between about 250 ml/min and about 300 ml/min, from a storage medium. The composition may have a temperature between about 0° C. and about 100° C., for example, between about 20° C. and about 25° C.

A substrate disposed in the carrier head, for example, a polishing carrier head 202 as shown in FIG. 1, and is rotated and contacted with a rotating polishing article, for example, such as one described herein and disposed in the polishing pad assembly 222, to provide mechanical abrasion between the substrate and polishing article at step 330.

The substrate may be rotated in the polishing carrier head 202 at a velocity between about 5 and about 200 rpm and also moved linearly at a velocity between about 5 and about 25 centimeters per second (cps) in a direction radial to the basin 204. The basin 204 containing the polishing composition may be rotated at a velocity between about 3 rpm and about 100 rpm. For a 200 mm diameter substrate, the substrate may be rotated at a rotational velocity between about 7 rpm and about 100 rpm and a linear (e.g., radial) velocity of about 10 centimeters per second (cps), and the basin 204 may be rotated at a rotational velocity of about 5 to about 40 rpm. For a 300 mm diameter substrate, the substrate may be rotated at a rotational velocity between about 7 rpm and about 50 rpm and a linear (e.g., radial) velocity of about 10 centimeters per second, and the basin 204 may be rotated at a rotational velocity of about 5 to about 20 rpm.

The substrate and polishing article are contacted at a pressure of less than about 2 psi (13.8 kPa). For example, a pressure between the substrate and polishing pad in the range between about 0.01 psi (69 Pa) and about 1.5 psi (10.2 kPa), for example, a pressure between about 0.1 psi (690 Pa) and less than about 0.5 psi (3.4 kPa), may be used for polishing the substrate surface. In one aspect of the process, a pressure of about 0.2 psi (1.4 kPa) or less is used.

Power may be applied to the substrate having a conductive material layer formed thereon in a process apparatus, such as cell 200 described above, by applying a bias between an electrode and the substrate to remove the conductive material at Step 340.

In one embodiment of an electrochemical polishing process, the polishing pad assembly 222 is disposed in a basin containing a composition described herein. The substrate 208 is exposed to the polishing composition and is in electrical contact with conductive pad 203. A bias from a power source 224 is then applied between the substrate 208 and the conductive pad 203. The bias is generally provided to produce anodic dissolution of the conductive material from the surface of the substrate at a current density up to about 100 mA/cm² which correlates to an applied current of about 40 amps to process substrates with a diameter up to about 300 mm. For example, a 200 mm diameter substrate may have a current density from about 0.01 mA/cm² to about 50 mA/cm², which correlates to an applied current from about 0.01 A to about 20 A. The invention also contemplates that the bias may be applied and monitored by volts, amps and watts. For example, in one embodiment, the power supply may apply a power between about 0 watts and 100 watts, a voltage between about 0 V and about 10 V, and a current between about 0 amps and about 10 amps.

The bias may be varied in power and application depending upon the user requirements in removing material from the substrate surface. The bias may also be applied by an electrical pulse modulation technique, which applies a constant current density or voltage for a first time period, then applies a constant reverse current density or voltage for a second time period, and repeats the first and second steps, as is described in co-pending U.S. Pat. No. 6,379,223, entitled “Method And Apparatus For Electrochemical Mechanical Planarization”, issued on Apr. 22, 2002, which is incorporated by reference herein to the extent not inconsistent with the claimed aspects and disclosure herein.

The substrate is typically exposed to the polishing composition and power application for a period of time sufficient to remove at least a portion or all of the desired material disposed thereon. For example, the substrate may be exposed to the polishing composition and power between about 5 seconds and about 300 seconds, but may vary. For example, if a desired substrate throughput is about 40 substrates per hour, the exposure time to the polishing composition may be about 100 seconds.

The abrasive content of the polishing composition during processing may be modified to provide selective polishing of the substrate surface at step 350. In one embodiment of modifying the abrasive content of the polishing composition, additional abrasives may be introduced into the processing station during processing with a polishing composition having an initial concentration of abrasives to enhance the polishing process at one or more particular portions of the process using a composition having an increased concentration of abrasive particles.

Examples of polishing compositions described herein may have an initial abrasive concentration of up to about 0.4 wt. %. For example an abrasive concentration between about 0.01 wt. % and about 0.4 wt. %, such as between about 0.01 wt. % and about 0.4 wt. %, may be used for electrochemical mechanical polishing of the substrate. Alternatively, the initial abrasive concentration may be about 0 wt. %. Abrasive particles may be added to the composition to increase the abrasive concentration between greater than about 0.4 wt. % and about 4 wt. %, for example, between about 2 wt. % and about 3 wt. % for electrochemical mechanical polishing of the substrate at enhanced abrasive content. The process for increased abrasion content are provided for illustrative purposes, and the invention contemplates that various process may begin with higher or lower abrasive concentration and have additional abrasives added at higher and lower increments than the examples herein.

The abrasive particle concentration may be introduced by a step increase application or a pulse application. In a step increase application, the abrasive particle concentration of the composition is increased and maintained at a selected, consistent concentration. The step increase application may be a multi-step increase in abrasive concentration to a selected level and/or may be a linear slope or exponential increase of the abrasive concentration to a selected level for electrochemical mechanical polishing the substrate.

For example, in an increased and maintained concentration, the abrasive particles concentration may be increased from an initial concentration, for example, about 0.15 wt % or 0.4 wt. % to a selected concentration, for example, about 0.7 wt. % or about 4 wt. %, to complete polishing. For example, in a multi-step increase application, the abrasive particles concentration may be increased from an initial concentration, for example, about 0.4 wt. %, to an intermediate concentration, for example, between about greater than 0.4 wt. % and less than about 4 wt. %, and then a selected concentration, for example, about 4 wt. % or greater, to complete polishing. In an linear slope increase application the abrasive concentration is continually increased from an initial concentration, for example, about 0.4 wt. %, to a selected concentration, for example, about 4 wt. % to complete polishing.

In a pulse application process, abrasive particle concentration is increased from an initial concentration to a selected concentration for a selected duration, and then subsequently provided at a reduced concentration or at a previous concentration. For example, a pulse application process may comprise increasing the abrasive particles concentration from about 0.4 wt. % to about 4 wt. % for a period of time and then reducing the abrasive particles concentration to about 0.4 wt. %. The pulse application process may comprise more than one pulse during processing, and each pulse used may have a separate abrasive particle concentration.

The concentration change may occur by a consistent supply of abrasives to maintain a static abrasive concentration. The subsequent abrasive concentrations, and previous abrasive concentration if more than one pulse is used, may be provided dynamically by supplying a increased amount of abrasive at one time over the initial concentration and then through process consumption, allow the abrasive concentration to return to the previous initial amount. For example, the initial concentration is steadily provided at about 0.4 wt. %, with a single pulse of about 4 wt. %, which may be consumed by the process and return the concentration to the initial steady level of about 0.4 wt. %. Alternatively, the amount of abrasives provided may be at reduced levels or simply ended for a period of time to reduce the abrasive concentration.

In one example of the process described herein, a substrate may be electrochemical mechanical polished with a initial abrasive concentration of between about 0.01 wt. % and about 0.4 wt. %, for example, between about 0.1 wt. % and about 0.2 wt. %, and then the substrate is polished by the pulse application process with a selected abrasive concentration of greater than about 0.4 wt. % for example, between about 2 wt. % and about 3 wt. % or between about 0.6 wt. % and about 1 wt. %.

The controller 140 can be adapted to control the abrasive concentration profile of the polishing composition to the processing cell as a function of time by the use of a metering pump 281 that injects a selected amount of abrasive composition into the polishing composition flowing into the processing cell 200 and across the surface of the substrate. The injected amount of abrasive composition from the abrasive source 280 has a higher concentration of abrasive particles than the polishing composition delivered from the polishing composition source 242. By varying the amount of the abrasive composition from the abrasive source 280 and holding the flow rate through the processing cell 200 to a selected level, the concentration of the abrasive component during polishing may be modified and pulsed as described herein. The abrasive composition from the abrasive source 280 may comprise the same or substantially the same non-abrasive components as the polishing compositions being delivered to the polishing process.

Alternatively, when polishing compositions used in processing substrates are recirculated through the process cell 200 in order to control and maintain the abrasive content to some selected level, the amount of abrasives can be completed by use of a filtering and dosing system (not shown). The filtering and dosing system will to remove all of the abrasives in the filtering area of the system and then dose into the leftover abrasive free composition a selected concentration of abrasives that can then be delivered to the polishing composition source 242 and thus the process cell 200.

The abrasive particles concentrations may be changed at selected portions of the polishing process. For example, before an underlying barrier layer is exposed a pulse of abrasive particles may be added to more effectively polish the conductive material/barrier layer material interface and residual materials. Additionally, for example, a steady increase in abrasive particle concentration may be applied as increasing amounts of barrier layer material are exposed to the polishing composition. It is believed that the use of increase abrasive particles as applied to polishing of barrier layer materials removes or “break” residual conductive and barrier materials that provide sufficient conductance for anodic dissolution to result in dishing of conductive material filled features.

The removal of the residual conductive materials for example, the conductive material, the seed layer, the barrier materials, is a self-limiting process that will reduce the effective electrochemical anodic dissolution rate as the conductive materials are removed from the substrate surface due to the increase in resistance to current flow in the remaining material. The significant change in the resistance in the conductive materials towards the end of the polishing process allows the user to detect the endpoint of the process by monitoring the change in current and/or voltage as the electrochemical process proceeds. An example of an exemplary endpoint detection process that may take advantage of the processes described herein is more fully described in U.S. patent application Ser. No. 10/056,316, filed on Jan. 22, 2002, and in U.S. patent application Ser. No. 10/391,324, filed on Mar. 18, 2003, which are incorporated by reference herein to the extent not inconsistent with the disclosure and claimed aspects herein.

Additionally or alternatively, other processing parameters and composition components may be modified to enhance barrier removal rates during electrochemical mechanical polishing of the conductive material layer. For example, an applied bias may be reduced, or turned off, when a significant portion of the barrier material is exposed to prevent the conductive material(s), such as copper, remaining in the exposed features on the surface of the substrate from being overpolished. Copper is more conductive and generally has a lower over-potential than most barrier materials and thus, copper has a higher removal rate under an applied bias than most barrier materials, such as tantalum. Reducing the applied bias reduces the can significantly reduce the removal rate of copper with a slighter reduction in the corresponding barrier removal rate. The adjusted removal rates allow for more barrier material to be removed during copper removal, thereby removing barrier residues while minimizing excess polishing of copper in features. If the power is turned off, the material will be removed by chemical mechanical polishing.

In another aspect, relative removal rates of the copper material and the barrier material are adjusted by relative changes in the concentrations of polishing composition components. For example, corrosion inhibitor are observed to reduce copper removal rate with relatively minimal impact on barrier removal rates; and increasing corrosion inhibitor concentration when barrier materials are exposed to the composition during a polishing process is believed to suppress copper removal rates and allow for more barrier material to be removed during copper removal.

In another aspect, the downforce pressure applied between the substrate and polishing pad may be increased in the pulse fashion described herein to apply greater pressure at the barrier layer polishing and barrier residue polishing portions of the process. The greater pressure application is believed to correspond to a greater removal rate of barrier material for the duration and result in greater barrier material removal and breaking of the barrier layer materials.

Following the electrochemical mechanical processing step, the substrate may then be further processed to planarize the substrate surface at step 370. For example, the substrate may be transferred to a chemical mechanical polishing apparatus to remove any residual barrier materials, to buff the substrate surface to remove scratches and other topographical defects, to clean the substrate surface, and to perform any dielectric material polishing, such as oxide etch or removal, to produce a planarized surface having conductive material features formed therein.

While the following processes are drawn to performing the abrasive concentration varying process on a single platen, the invention contemplates performing the invention on two or more platens.

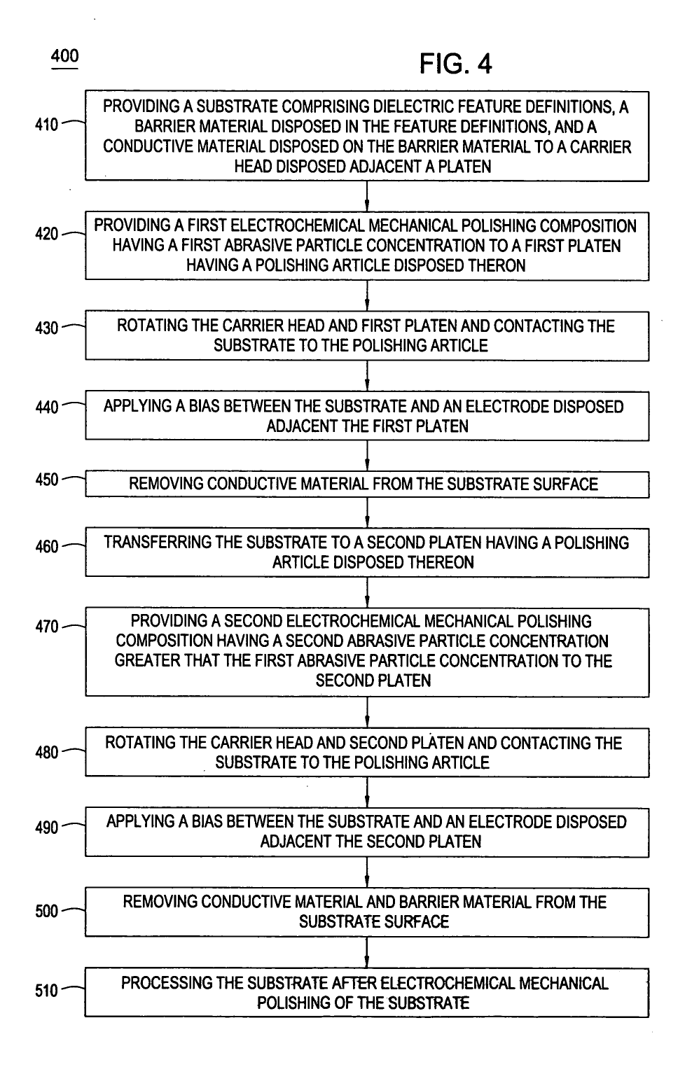

FIG. 4 is a flow chart of one embodiment of a two platen electrochemical mechanical polishing process 400. A substrate is disposed in a carrier head as described herein and is provided to a first polishing station having a polishing article disposed on a platen at step 410. A first composition having a first concentration of abrasive particles is delivered to the first processing station to provide chemical activity to any substrate exposed thereto at step 420. The substrate and platen are rotated and the substrate is contacted with the polishing article to provide mechanical abrasion of the substrate surface at step 430. A bias is applied between the substrate and an electrode disposed in the polishing station to provide anodic dissolution to the substrate surface at step 440. Bulk conductive material is removed from the substrate surface between step 420 and step 450.

The substrate may then be transferred to a second polishing station having a polishing article disposed on a platen at step 460. A composition having a second concentration of abrasive particles greater than the first concentration of abrasive particles is delivered to the second processing station to provide chemical activity to any substrate exposed thereto at step 470. The second concentration may be applied by a pulse process described herein. The substrate and platen are rotated and the substrate is contacted with the polishing article to provide mechanical abrasion of the substrate surface at step 480. A bias is applied between the substrate and an electrode disposed in the polishing station to provide anodic dissolution to the substrate surface at step 490. Any remaining conductive material and barrier layer material is removed from the substrate surface between step 470 and step 500. The substrate may then be further process, for example, to remove any barrier material remaining, buffing any exposed dielectric material, or post-treat to remove any surface defects, in step 510.

In one example, in a one platen electrochemical polishing process may include a first polishing composition having an initial abrasive concentration of up to about 0.4 wt. %. For example, an abrasive concentration between about 0.01 wt. % and about 0.4 wt. %, such as between about 0.1 wt. % and about 0.2 wt. % by weight of silica (SiO₂) abrasive particles, for example, about 0.15 wt. %, may be used for electrochemical mechanical polishing of the substrate. The first polishing composition may further include between about 0.01 wt. % and about 4 wt. % of a chelating agent, such as about 2% by volume ethylenediamine, between about 0.01 wt. % and about 8 wt. % of an organic salt, such as about 2% by weight ammonium citrate, between about 0.01 wt. % and about 1 wt. % of a corrosion inhibitor, such as about 0.3% by weight benzotriazole, optionally, between about 0.1% and about 3% by volume or weight, for example, about 0.45% hydrogen peroxide, and between about 2 wt. % and about 6 wt. % of an electrolyte, such as about 6% by volume phosphoric acid, and a solvent, such as deionized water. The pH of the composition may be about 6, which may be achieved by, for example, the composition further including between about 2% and about 6% by volume of potassium hydroxide to adjust the pH to the preferred range.

In this embodiment the first polishing composition can be supplied to the basin and the substrate is rotated at a carrier head rotational speed between about 7 rpm and about 100 rpm, the polishing article is rotated at a platen rotational speed between about 5 rpm and about 40 rpm, the substrate and the polishing article are contacted at a contact pressure between about 0.01 psi and about 1 psi, such as 0.2 psi, and a current density of between about 0.01 and about 40 amps/cm², such as to provide a bias of about 2.9 volts, is applied to the substrate surface.

During polishing the abrasive concentration is pulse at a second abrasive concentration between about 2 wt. % and about 3 wt. % or between about 0.5 wt. % and about 0.7 wt. %, for example, about 0.7 wt. %, for a period between about 0.01 seconds and about 10 seconds when barrier material are exposed for polishing by the process of the first platen.

Alternatively, for a two platen process, the second platen electrochemical polishing process may include the same polishing composition as the first polishing composition with a higher abrasive concentration up to about 4 wt. %, such as an abrasive concentration between about 2 wt. % and about 3 wt. %, for the electrochemical mechanical polishing of the substrate at the second platen.

Following copper polishing and breaking of the barrier layer materials, the substrate may be polished to remove any remaining barrier layer materials and buffed to remove any scratched formed in the materials including dielectric materials. The barrier removal processes may be chemical mechanical polishing process, which a chemical mechanical polishing station may be disposed on the same system as described herein, usually at the second or third platen station. Suitable barrier polishing processes may include barrier polishing composition including reducing agents. Examples of suitable barrier polishing composition and processes are described in U.S. patent application Ser. No. 10/187,857, filed on Jun. 27, 2002, entitled “Barrier Removal at Low Polishing Pressures” and U.S. patent application Ser. No. 10/193,810, filed on Jul. 11, 2002, entitled “Dual Reducing Agents for Barrier Removal in Chemical Mechanical Polishing”, which are incorporated by reference herein to the extent not inconsistent with the claimed aspects and disclosure herein.

Other suitable barrier polishing compositions and process are described in U.S. patent application Ser. No. 10/215,521, filed on Aug. 8, 2002, entitled “Selective Removal Of Tantalum-Containing Barrier Layer During Metal CMP”, U.S. Pat. No. 6,709,316, issued on Mar. 23, 2004, entitled “Method And Apparatus For Two-Step Barrier Layer Polishing”, U.S. patent application Ser. No. 09/755,717, filed on Jan. 5, 2001, entitled “Tantalum Removal During Chemical Mechanical Polishing”, and U.S. Pat. No. 6,524,167, issued on Feb. 25, 2003, which are incorporated by reference herein to the extent not inconsistent with the claimed aspects and disclosure herein. Alternatively, the third platen may be an electrochemical mechanical processing cell and the barrier removal process may be an electrochemical mechanical process. The barrier polishing processes provided herein are illustrative and should not be construed or interpreted as limiting the scope of the invention.

It has been observed that a substrate processed with the polishing composition described herein has improved surface finish, including less surface defects, such as dishing, erosion (removal of dielectric material surrounding metal features), and scratches, as well as improved planarity.

Polishing Compositions

Suitable polishing compositions that may be used with the processes described herein to planarize metals, such as copper, may comprise an acid based electrolyte system, one or more chelating agents, one or more corrosion inhibitors, one or more inorganic or organic acid salts, one or more pH adjusting agents to produce a pH between about 2 and about 10, at least one oxidizer, and abrasive particulates.

Although the polishing compositions are particularly useful for removing copper, it is believed that the polishing compositions also may be used for the removal of other conductive materials, such as aluminum, platinum, tungsten, titanium, titanium nitride, tantalum, tantalum nitride, cobalt, gold, silver, ruthenium and combinations thereof. Mechanical abrasion, such as from contact with the conductive polishing article 203 may be used with the polishing composition to improve planarity and improve removal rate of these conductive materials.

The polishing composition includes an acid based electrolyte system for providing electrical conductivity. Suitable acid based electrolyte systems include, for example, phosphoric acid based electrolytes, sulfuric acid, nitric acid, perchloric acid, acetic acid, citric acid, salts thereof and combinations thereof. Suitable acid based electrolyte systems include an acid electrolyte, such as phosphoric acid, boric acid and/or citric acid, as well as acid electrolyte derivatives, including ammonium, potassium, sodium, calcium and copper salts thereof. The acid based electrolyte system may also buffer the composition to maintain a desired pH level for processing a substrate.

Examples of suitable acid based electrolytes include compounds having a phosphate group (PO₄³⁻), such as, phosphoric acid, copper phosphate, potassium phosphates (K_{X}H_{(3-X)}PO₄) (x=1, 2 or 3), such as potassium dihydrogen phosphate (KH₂PO₄), dipotassium hydrogen phosphate (K₂HPO₄), ammonium phosphates ((NH₄)_{X}H_{(3-X)}PO₄) (x=1, 2 or 3), such as ammonium dihydrogen phosphate ((NH₄)H₂PO₄), diammonium hydrogen phosphate ((NH₄)₂HPO₄), compounds having a nitrite group (NO₃¹⁻), such as, nitric acid or copper nitrate, compounds having a boric group (BO₃³⁻), such as, orthoboric acid (H₃BO₃) and compounds having a sulfate group (SO₄²⁻), such as sulfuric acid (H₂SO₄), ammonium hydrogen sulfate ((NH₄)HSO₄), ammonium sulfate, potassium sulfate, copper sulfate, derivatives thereof and combinations thereof. The invention also contemplates that conventional electrolytes known and unknown may also be used in forming the composition described herein using the processes described herein.

The acid based electrolyte system may contains an acidic component that can take up about 1 to about 30 percent by weight (wt %) or volume (vol %) of the total composition of composition to provide suitable conductivity for practicing the processes described herein. Examples of acidic components include dihydrogen phosphate and/or diammonium hydrogen phosphate and may be present in the polishing composition in amounts from about 15 wt % to about 25 wt %. Alternately, phosphoric acid may be present in concentrations up to 30 wt %, for example, between about 2 wt % and about 6 wt %.

One aspect or component of the present invention is the use of one or more chelating agents to complex with the surface of the substrate to enhance the electrochemical dissolution process. In any of the embodiments described herein, the chelating agents can bind to a conductive material, such as copper ions, increase the removal rate of metal materials and/or improve dissolution uniformity across the substrate surface. The metal materials for removal, such as copper, may be in any oxidation state, such as 0, 1, or 2, before, during or after ligating with a functional group. The functional groups can bind the metal materials created on the substrate surface during processing and remove the metal materials from the substrate surface. The chelating agents may also be used to buffer the polishing composition to maintain a desired pH level for processing a substrate. The chelating agents may also form or enhance the formation of a passivation layer on the substrate surface.

The one or more chelating agents can include compounds having one or more functional groups selected from the group of amine groups, amide groups, carboxylate groups, dicarboxylate groups, tricarboxylate groups, hydroxyl groups, a mixture of hydroxyl and carboxylate groups, and combinations thereof. The one or more chelating agents may also include salts of the chelating agents described herein. The polishing composition may include one or more chelating agents at a concentration between about 0.1% and about 15% by volume or weight, but preferably utilized between about 0.1% and about 4% by volume or weight. For example, about 2% by volume of ethylenediamine may be used as a chelating agent.

Examples of suitable chelating agents having one or more carboxylate groups include citric acid, tartaric acid, succinic acid, oxalic acid, amino acids, salts thereof, and combinations thereof. For example, chelating agents may include ammonium citrate, potassium citrate, ammonium succinate, potassium succinate, ammonium oxalate, potassium oxalate, potassium tartrate, and combinations thereof. The salts may have multi-basic states, for example, citrates have mono-, di- and tri-basic states. Other suitable acids having one or more carboxylate groups include acetic acid, adipic acid, butyric acid, capric acid, caproic acid, caprylic acid, glutaric acid, glycolic acid, formaic acid, fumaric acid, lactic acid, lauric acid, malic acid, maleic acid, malonic acid, myristic acid, plamitic acid, phthalic acid, propionic acid, pyruvic acid, stearic acid, valeric acid, derivatives thereof, salts thereof and combinations thereof. Further examples of suitable chelating agents include compounds having one or more amine and amide functional groups, such as ethylenediamine (EDA), diethylenetriamine, diethylenetriamine derivatives, hexadiamine, amino acids, glycine, ethylenediaminetetraacetic acid (EDTA), methylformamide, derivatives thereof, salts thereof and combinations thereof. For example, EDTA includes the acid as well as a variety of salts, such as sodium, potassium and calcium (e.g., Na₂EDTA, Na₄EDTA, K₄EDTA or Ca₂EDTA).

In any of the embodiments described herein, the inorganic or organic acid salts may be used to perform as a chelating agent. The polishing composition may include one or more inorganic or organic salts at a concentration between about 0.1% and about 15% by volume or weight of the composition, for example, between about 0.1% and about 8% by volume or weight. For example, about 2% by weight of ammonium citrate may be used in the polishing composition.

Examples of suitable inorganic or organic acid salts include ammonium and potassium salts or organic acids, such as ammonium oxalate, ammonium citrate, ammonium succinate, monobasic potassium citrate, dibasic potassium citrate, tribasic potassium citrate, potassium tartarate, ammonium tartarate, potassium succinate, potassium oxalate, and combinations thereof. Additionally, ammonium and potassium salts of the carboxylate acids may also be used.

In any of the embodiments described herein, the corrosion inhibitors can be added to reduce the oxidation or corrosion of metal surfaces by forming a passivation layer that minimizes the chemical interaction between the substrate surface and the surrounding electrolyte. The layer of material formed by the corrosion inhibitors thus tends to suppress or minimize the electrochemical current from the substrate surface to limit electrochemical deposition and/or dissolution. The polishing composition may include between about 0.001% and about 5.0% by weight of the organic compound from one or more azole groups. The commonly preferred range being between about 0.2% and about 0.4% by weight.

Examples of organic compounds having azole groups include benzotriazole (BTA), mercaptobenzotriazole, 5-methyl-1-benzotriazole (TTA), and combinations thereof. Other suitable corrosion inhibitors include film forming agents that are cyclic compounds, for example, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. Other corrosion inhibitor includes urea and thiourea among others.

Additionally or alternatively, polymeric inhibitors, for non-limiting examples, polyalkylaryl ether phosphate or ammonium nonylphenol ethoxylate sulfate, may be used in replacement or conjunction with azole containing corrosion inhibitors in an amount between about 0.002% and about 1.0% by volume or weight of the composition.

One or more pH adjusting agents is preferably added to the polishing composition to achieve a pH between about 2 and about 10, and preferably between a pH of about 3 and about 7. The amount of pH adjusting agent can vary as the concentration of the other components is varied in different formulations, but in general the total composition may include up to about 70 wt % of the one or more pH adjusting agents, but preferably between about 0.2% and about 25% by volume. Different compounds may provide different pH levels for a given concentration, for example, the composition may include between about 0.1% and about 10% by volume of a base, such as potassium hydroxide, ammonium hydroxide, sodium hydroxide or combinations thereof, providing the desired pH level.

The one or more pH adjusting agents can be chosen from a class of organic acids, for example, carboxylic acids, such as acetic acid, citric acid, oxalic acid, phosphate-containing components including phosphoric acid, ammonium phosphates, potassium phosphates, and combinations thereof, or a combination thereof. Inorganic acids including phosphoric acid, sulfuric acid, hydrochloric, nitric acid, derivatives thereof and combinations thereof, may also be used as a pH adjusting agent in the polishing composition.

The balance or remainder of the polishing compositions described herein is a solvent, such as a polar solvent, including water, preferably deionized water. Other solvent may be used solely or in combination with water, such as organic solvents. Organic solvents include alcohols, such as isopropyl alcohol or glycols, ethers, such as diethyl ether, furans, such as tetrahydrofuran, hydrocarbons, such as pentane or heptane, aromatic hydrocarbons, such as benzene or toluene, halogenated solvents, such as methylene chloride or carbon tetrachloride, derivatives, thereof and combinations thereof.

The polishing composition includes one or more surface finish enhancing and/or removal rate enhancing materials including abrasive particles, and optionally, one or more oxidizers.

Abrasive particles may be used to improve the surface finish and removal rate of conductive materials from the substrate surface during polishing. The addition of abrasive particles to the polishing composition can allow the final polished surface to achieve a surface roughness of that comparable with a conventional CMP process even at low pad pressures. Surface finish, or surface roughness, has been shown to have an effect on device yield and post polishing surface defects. Abrasive particles may comprise up to about 30 wt % of the polishing composition during processing. For example, a concentration between about 0.001 wt % and about 10 wt % of abrasive particles may be used in the polishing composition. Preferred abrasive particle concentrations are described herein.

Suitable abrasives particles include inorganic abrasives, polymeric abrasives, and combinations thereof. Inorganic abrasive particles that may be used in the electrolyte include, but are not limited to, silica, alumina, zirconium oxide, titanium oxide, cerium oxide, germania, or any other abrasives of metal oxides, known or unknown. For example, colloidal silica may be positively activated, such as with an alumina modification or a silica/alumina composite. The typical abrasive particle size used in one embodiment of the current invention is generally from about 1 nm to about 1,000 nm, preferably from about 10 nm to about 100 nm. Generally, suitable inorganic abrasives have a Mohs hardness of greater than 6, although the invention contemplates the use of abrasives having a lower Mohs hardness value.

The polymer abrasives described herein may also be referred to as “organic polymer particle abrasives”, “organic abrasives” or “organic particles.” The polymeric abrasives may comprise abrasive polymeric materials. Examples of polymeric abrasives materials include polymethylmethacrylate, polymethyl acrylate, polystyrene, polymethacrylonitrile, and combinations thereof.

The polymeric abrasives may have a Hardness Shore D of between about 60 and about 80, but can be modified to have greater or lesser hardness value. The softer polymeric abrasive particles can help reduce friction between a polishing article and substrate and may result in a reduction in the number and the severity of scratches and other surface defects as compared to inorganic particles. A harder polymeric abrasive particle may provide improved polishing performance, removal rate and surface finish as compared to softer materials.

The hardness of the polymer abrasives can be varied by controlling the extent of polymeric cross-linking in the abrasives, for example, a higher degree of cross-linking produces a greater hardness of polymer and, thus, abrasive. The polymeric abrasives are typically formed as spherical shaped beads having an average diameter between about 0.1 micron to about 20 microns or less.

The polymeric abrasives may be modified to have functional groups, e.g., one or more functional groups, that have an affinity for, i.e., can bind to, the conductive material or conductive material ions at the surface of the substrate, thereby facilitating the ECMP removal of material from the surface of a substrate. For example, if copper is to be removed in the polishing process, the organic polymer particles can be modified to have an amine group, a carboxylate group, a pyridine group, a hydroxide group, ligands with a high affinity for copper, or combinations thereof, to bind the removed copper as substitutes for or in addition to the chemically active agents in the polishing composition, such as the chelating agents or corrosion inhibitors. The substrate surface material, such as copper, may be in any oxidation state, such as 0, 1+, or 2+, before, during or after ligating with a functional group. The functional groups can bind to the metal material(s) on the substrate surface to help improve the uniformity and surface finish of the substrate surface.

Additionally, the polymeric abrasives have desirable chemical properties, for example, the polymer abrasives are stable over a broad pH range and are not prone to aggregating to each other, which allow the polymeric abrasives to be used with reduced or no surfactant or no dispersing agent in the composition.

Additionally or alternatively, inorganic particles coated with the polymeric materials described herein may also be used with the polishing composition. It is within the scope of the current invention for the polishing composition to contain polymeric abrasives, inorganic abrasives, the polymeric coated inorganic abrasives, and any combination thereof depending on the desired polishing performance and results.

One or more oxidizers may be used herein to enhance the removal or removal rate of the conductive material from the substrate surface. An oxidizing agent is generally an agent that reacts with a material by accepting an electron(s). In the current embodiment the oxidizer is used to react with the surface of the substrate that is to be polished, which then aids in the removal of the desired material. For example, an oxidizer may be used to oxidize a metal layer to a corresponding oxide or hydroxide, for example, copper to copper oxide. Existing copper that has been oxidized, including Cu¹⁺ ions, may further be oxidized to a higher oxidation state, such as Cu²⁺ ions, which may then promote the reaction with one or more of the chelating agents. Also, in some instances the oxidizing agent can be used in some chemistries (e.g., low pH) that can enhance the chemical etching of the surface of the substrate to further increase the removal rate from the anode surface. In cases where no bias is applied to the surface of the substrate the inhibitors and chelating agents will complex with the metal ions on the surface that become dislodged from the surface due to the relative motion and pressure applied by the conductive pad 203. The addition of abrasives can further improve the removal rate of the complexed metal ions due to the abrasive particles ability to increase that contact area between the conductive pad 203 and the substrate surface.

In the case of ECMP, the conductive layer on the substrate surface is biased anodically above a threshold potential, by use of the power source 224 and the electrode 209, thus causing the metal on the substrate surface to “oxidize” (i.e., a metal atom gives up one or more electrons to the power source 224). The ionized or “oxidized” metal atoms thus dissolve into the electrolyte composition with the help of components in the electrolyte. In the case where copper is the desired material to be removed, it can be oxidized to a Cu¹⁺ or a Cu²⁺ oxidation state. Due to the presence of the inhibitors and/or chelating agents found in the polishing composition, the electrochemical dissolution process of the metal ions into the electrolyte is more limited than a polishing composition which does not contain these components. The presence of the inhibitors and/or chelating agents also appears to have an effect on the attachment strength of the metal ion(s) and inhibitor and/or chelating agent complex to the surface of the substrate. It has been found that in one embodiment that the removal rate in an ECMP process can be increased by the addition of an oxidizing agent. It is thought that the oxidizing agent tends to further oxidize the metal ions formed due to the anodic bias, which in the case of copper brings it to the more stable Cu²⁺ oxidation state. The inhibitors and/or chelating agents found in the polishing composition complex with the oxidized metal ions which tend to have a lower attachment, or bond, strength due to the way the inhibitor bonds to the oxidized metal ion and metal surface. The lower attachment strength allows the complexed metal ion to be more easily and efficiently removed due to the interaction of the substrate surface and the conductive pad 203. The addition of abrasives to the ECMP polishing composition can further improve the removal rate of the complexed metal ions due to the abrasive particles' ability to increase contact area between the conductive pad 203 and the substrate surface.

The polishing composition may include one or more additive compounds. Additive compounds include electrolyte additives including, but not limited to, suppressors, enhancers, levelers, brighteners, stabilizers, and stripping agents to improve the effectiveness of the polishing composition in polishing of the substrate surface. For example, certain additives may decrease the ionization rate of the metal atoms, thereby inhibiting the dissolution process, whereas other additives may provide a finished, shiny substrate surface. The additives may be present in the polishing composition in concentrations up to about 15% by weight or volume, and may vary based upon the desired result after polishing.

Further, controlling the amounts and types of constituents of the polishing composition, such as corrosion inhibitors and oxidizers, can result in tuning the desired removal rate of the process. For example reduced amounts of corrosion inhibitor will result in an increase in the material removal rate as compared to compositions having higher corrosion inhibitor concentrations. In cases where the polishing composition does not contain corrosion inhibitors the ECMP material removal rate is greatly increased over a polishing composition which contains a corrosion inhibitor due to the formation of the metal ions and inhibitor complex which tends to shield the surface of the substrate to the electrolyte. Likewise reduced amounts of oxidizers will generally result in lower removal rates compared to compositions having higher oxidizer compositions. It has been suggested that at low concentrations of the oxidizer, the corrosion inhibitor and/or chelating agent can complex with a metal ion before it becomes oxidized further by the oxidizing agent due to kinetic effects limiting the supply of the oxidizer to the surface of the substrate. The corrosion inhibitor and metal ion complex can thus affect the removal efficiency due to the formation of the stronger attachment strength complexed metal ions. An example of a polishing composition described herein includes about 2% by volume ethylenediamine, about 2% by weight ammonium citrate, about 0.3% by weight benzotriazole, between about 0.1% and about 3% by volume or weight, for example, about 0.45% hydrogen peroxide, and/or about between about 0.01% and 1% by weight, for example 0.15% by weight, of abrasive particles, and about 6% by volume phosphoric acid. The pH of the composition is about 5, which may be achieved by, for example, the composition further including potassium hydroxide to adjust the pH to the preferred range. The remainder of the polishing composition is deionized water.

The oxidizer can be present in the polishing composition in an amount ranging between about 0.01% and about 90% by volume or weight, for example, between about 0.1% and about 20% by volume or weight. In an embodiment of the polishing composition, between about 0.1% to about 15% by volume or weight of hydrogen peroxide is present in the polishing composition. In one embodiment, the oxidizer is added to the rest of the polishing composition just prior to beginning the ECMP process. Examples of suitable oxidizers include peroxy compounds, e.g., compounds that may disassociate through hydroxy radicals, such as hydrogen peroxide and its adducts including urea hydrogen peroxide, percarbonates, and organic peroxides including, for example, alkyl peroxides, cyclical or aryl peroxides, benzoyl peroxide, peracetic acid, and ditertbutyl peroxide. Sulfates and sulfate derivatives, such as monopersulfates and dipersulfates may also be used including for example, ammonium peroxydisulfate, potassium peroxydisulfate, ammonium persulfate, and potassium persulfate. Salts of peroxy compounds, such as sodium percarbonate and sodium peroxide may also be used.

The oxidizing agent can also be an inorganic compound or a compound containing an element in its highest oxidation state. Examples of inorganic compounds and compounds containing an element in its highest oxidation state include but are not limited to periodic acid, periodate salts, perbromic acid, perbromate salts, perchloric acid, perchloric salts, perbonic acid, nitrate salts (such as cerium nitrate, iron nitrate, ammonium nitrate), ferrates, perborate salts and permanganates. Other oxidizing agents include bromates, chlorates, chromates, iodates, iodic acid, and cerium (IV) compounds such as ammonium cerium nitrate.

Surfactants may be one such additive compound in the polishing composition. One or more surfactants may be used in the polishing composition to increase the dissolution or solubility of materials, such as metals and metal ions or by-products produced during processing, improve chemical stability, and reduce decomposition of components of the polishing composition. The one or more surfactants can comprise a concentration between about 0.001% and about 10% by volume or weight of the polishing composition. A concentration between about 0.01% and about 2% by volume or weight, for example between about 0.1% and about 1% by volume or weight, of the surfactants may be used in one embodiment of the polishing composition. The one or more surfactants may include non-ionic surfactants as well as ionic surfactants including anionic surfactants, cationic surfactants, amphoteric surfactants, and ionic surfactants having more than one ionic functional group, such as Zweitter-ionic surfactants. Dispersers or dispersing agents are considered to be surfactants as surfactants are used herein.

Other examples of additives include one or more leveling agents, which are broadly defined herein as additives that suppress dissolution current on the surface of a substrate. Leveling agents suppress dissolution current by attaching to conductive materials, by inhibiting the electrochemical reactions between the electrolyte and conductive material, and/or form depolarizing agents that limit electrochemical reactions. A concentration of leveling agents between about 0.005% and about 10% by volume or weight, for example, between about 0.05% and about 2% by volume or weight of the electrolyte composition can be used.

Leveling agents include, but are not limited to, polyethylene glycol (PEG) and polyethylene glycol derivatives. Other leveling agents which can be employed in the process described herein include any employed in the electroplating or electropolishing art, such as polyamines, polyamides and polyimides including polyethyleneimine, polyglycine, 2-amino-1-naphthalenesulfonic acid, 3-amino-1-propanesulfonic acid, 4-aminotoluene-2-sulfonic acid. Leveling agents may be added to the composition in a range from about 0.05% to about 5% by volume or weight of the composition. For example, PEG may be added to a polishing composition with a concentration about 0.2 wt %.

Suppressors, such as electrically resistive additives that reduce the conductivity of the polishing composition may be added to the composition in a range from about 0.005% to about 2% by volume or weight of the composition. Suppressors include polyacrylamide, polyacrylic acid polymers, polycarboxylate copolymers, coconut diethanolamide, oleic diethanolamide, ethanolamide derivatives, or combinations thereof.

One or more stabilizers may be present in an amount that is sufficient to produce measurable improvements in composition stability. The one or more stabilizers may be present in an amount ranging from about 100 ppm to about 5.0 weight percent (wt %). Non-limiting examples of preferred stabilizers include but are not limited to phosphoric acids and phosphoric acid derivatives including aminotri(methylenephosphonic) acid, 1-hydroxyethylidene-4-diphosphonic acid, hexamethylenediaminetetramethylene phosphoric acid, and diethylenetetramine pentamethylenephosphonic acid, and derivative salts thereof.

Accelerators are another example of an additive that may be included in the polishing composition. Accelerators increase electrochemical reactions of metals disposed on the substrate surface to increase metal removal. The composition may include one or more accelerators at a concentration between about 0.001% and about 1% by volume or weight, for example, between about 0.25% and about 0.8% by volume or weight. Accelerators may include sulfur-containing compounds, such as sulfite or di-sulfate.

Further examples of additives to the polishing composition are more fully described in U.S. patent application Ser. No. 10/141,459, filed on May 7, 2002, which is incorporated by reference herein to the extent not inconsistent with the claimed aspects and disclosure herein.

Examples of suitable polishing compositions include compositions of varying compositions may be used to remove bulk material and residual material, such as copper and/or copper alloys, as well as to remove barrier materials, such as tantalum nitrides or titanium nitrides. Specific formulations of the polishing compositions are used to remove the particular materials. Generally, the compositions described herein are much more conductive than traditional chemical mechanical polishing (CMP) compositions. The compositions described herein have a conductivity of about 10 mS or higher, while traditional CMP compositions have a conductivity from about 3 mS to about 5 mS. The conductivity of the composition greatly influences that rate at which the electrochemical mechanical polishing process advances, i.e., more conductive compositions have a faster material removal rate. For removing bulk material, the ECMP composition has a conductivity of about 10 mS or higher, preferably in a range from about 30 mS to about 60 mS. For residual material, the ECMP composition has a conductivity of about 10 mS or higher, preferably in a range from about 15 mS to about 40 mS.

A first polishing composition may be used to remove bulk material may include phosphoric acid, at least one chelating agent, a corrosion inhibitor, a salt, an oxidizer, or abrasive particulates, with the processes described herein. For example, a first polishing composition may include from about 1 wt % to about 10 wt % of phosphoric acid; from about 0.1 wt % to about 6 wt % of the at least one chelating agent; from about 0.01 wt % to about 1 wt % of a corrosion inhibitor; from about 0.5 wt % to about 10 wt % of a salt, such as ammonium citrate or copper citrate; and from about 0.2 wt % to about 5 wt % of an oxidizer. The polishing composition may also have an abrasive concentration between about 0.05 wt % to about 1 wt % of abrasive particulates. The abrasive concentration may be pulsed as described herein or have varying amounts of abrasive concentration during processing. Also, a first polishing composition may have a pH adjusting agent in a concentration to maintain a pH from about 4 to about 7. Generally, a solvent is added to the composition, such as de-ionized water.

The first polishing composition includes at least one chelating agent, such as EDA, EDTA, citric acid, ammonium citrate, salts thereof, derivatives thereof and combinations thereof. The corrosion inhibitor of the first polishing composition may include BTA, TTA, salts thereof, derivatives thereof and combinations thereof. Salts may be added to the first polishing composition or may be formed in situ, such as by an acid/base type reaction. Salts may be inorganic, organic or combinations thereof and include cations such as ammonium, potassium, sodium, calcium and anions such as citrate, oxalate, succinate and tartrate. A pH adjusting agent includes potassium hydroxide, ammonium hydroxide or combinations thereof. An oxidizer, such as hydrogen peroxide and/or abrasive particulates, such as colloidal silica activated with alumina may be added to the first polishing composition.

A second polishing composition may be used to remove residual material may include phosphoric acid, at least one chelating agent, a corrosion inhibitor, a salt, an oxidizer, abrasive particulates, with the process described herein. For example, a second polishing composition may include from about 0.1 wt % to about 5 wt % of phosphoric acid; from about 0.1 wt % to about 5 wt % of the at least one chelating agent; from about 0.01 wt % to about 1 wt % of a corrosion inhibitor; from about 0.1 wt % to about 5 wt % of a salt; from about 0.01 wt % to about 3 wt % of an oxidizer; and from about 0.05 wt % to about 5 wt % of abrasive particulates. The second abrasive concentration may be pulsed as described herein or have varying amounts of abrasive concentration during processing. The abrasive concentration may also be greater than the concentration for a bulk polishing composition as described herein. Also, a second polishing composition may have a pH adjusting agent in a concentration to maintain a pH from about 4 to about 7. Generally, a solvent is added to the composition, such as de-ionized water.

The at least one chelating agent of the second polishing composition may include glycine, EDA, EDTA, citric acid, ammonium citrate, salts thereof, derivatives thereof and combinations thereof. The corrosion inhibitor of the second polishing composition may include BTA, TTA, salts thereof, derivatives thereof and combinations thereof. Salts may be added to the second polishing composition or may be formed in situ, such as by an acid/base type reaction. Salts may be inorganic, organic or combinations thereof and include cations such as ammonium, potassium, sodium, calcium and anions such as citrate, oxalate, succinate and tartrate. A pH adjusting agent includes potassium hydroxide, ammonium hydroxide or combinations thereof. An oxidizer, such as hydrogen peroxide and/or abrasive particulates, such as colloidal silica activated with alumina may be added to the second polishing composition. In one example, a second polishing composition includes BTA and glycine. In another example, a second polishing composition includes BTA, EDA and ammonium citrate. Also, some of the second polishing compositions contain leveling agents, such as PEG.***

Further examples of additives to the polishing composition are more fully described in U.S. patent application Ser. No. 10/141,459, filed on May 7, 2002, which is incorporated by reference herein to the extent not inconsistent with the claimed aspects and disclosure herein. Suitable polishing composition are disclosed in U.S. patent application Ser. No. 10/378,097, filed on Feb. 26, 2003, and U.S. patent application Ser. No. 10/456,220, filed on Jun. 6, 2003, which are incorporated by reference herein to the extent not inconsistent with the claimed aspects and disclosure herein

The balance or remainder of the polishing compositions described above is a solvent, such as a polar solvent, including water, preferably deionized water, and organic solvents, for example, alcohols or glycols.

While the foregoing is directed to embodiments of the present invention, other and further embodiments of the invention may be devised without departing from the basic scope thereof, and the scope thereof is determined by the claims that follow.

1. A method of processing a substrate having a barrier material layer and a conductive material layer formed on the barrier material layer, comprising:
disposing a substrate in an apparatus comprising a first electrode and a second electrode, wherein the substrate is in electrical contact with the second electrode;
providing an polishing composition between the first electrode and the substrate, wherein the polishing composition comprises a first concentration of abrasive particles;
applying a bias between the first electrode and the second electrode;
providing relative motion between the substrate and the polishing article;
removing conductive layer material from the substrate;
introducing abrasive particles to the polishing composition to form a second concentration of abrasive particles greater than a first concentration of abrasive particles; and
removing at least a portion of the barrier material layer from the substrate.

2. The method of claim 1, wherein the bias is applied to the substrate to initiate an anodic dissolution at a current density between about 0.01 milliamps/cm² and about 100 milliamps/cm².

3. The method of claim 1, wherein the providing relative motion between the substrate and the polishing article comprises providing a substrate to a carrier head at a carrier head rotation speed between about 7 rpm and about 100 rpm, providing a platen having a polishing pad thereon and having a platen rotational speed of between about 5 rpm and about 40 rpm, and contacting the substrate with the polishing pad at a contact pressure of between about 0.01 psi and about 1.5 psi.

4. The method of claim 3, wherein the pressure applied between the substrate and pad is between about 0.1 psi and less than about 0.5 psi.

5. The method of claim 1, wherein the first abrasive particle concentration comprises up to 0.4 wt. % of the composition.

6. The method of claim 1, wherein the second abrasive particle concentration comprises between greater than 0.4 wt. % to about 4 wt. % of the composition.

7. The method of claim 1, wherein the abrasive particles comprise inorganic abrasives, polymeric abrasives, polymeric coated abrasives, or combinations thereof.

8. The method of claim 1, wherein the conductive layer material comprises copper and the barrier layer material comprises tantalum, tantalum nitride, or combinations thereof.

9. A method of processing a substrate having a barrier material layer and a conductive material layer formed on the barrier material layer, comprising:
polishing a substrate by a first electrochemical mechanical polishing process having a first composition with a first abrasive particle concentration to remove a portion of the conductive material layer; and
polishing a substrate by a second electrochemical mechanical polishing process having a second composition with a second abrasive particle concentration greater than the first abrasive particle concentration to remove a second portion of the conductive material layer and at least a portion of the barrier material layer.

10. The method of claim 9, wherein the first abrasive particle concentration comprises up to 0.4 wt. % of the composition.

11. The method of claim 9, wherein the second abrasive particle concentration comprises from greater than 0.4 wt. % to about 4 wt. % of the composition.

12. The method of claim 9, wherein the first electrochemical polishing composition comprises providing a substrate to a carrier head at a carrier head rotation speed between about 7 rpm and about 1000 rpm, providing a platen having a polishing pad thereon and having a platen rotational speed of between about 5 rpm and about 40 rpm, contacting the substrate with the polishing pad at a contact pressure of between about 0.1 psi and about 1 psi, and applying a bias between the substrate and an electrode between about 0.01 watts/cm² and about 40 watts/cm².

13. The method of claim 9, wherein the second electrochemical polishing composition comprises providing a substrate to a carrier head at a carrier head rotation speed between about 7 rpm and about 1000 rpm, providing a platen having a polishing pad thereon and having a platen rotational speed of between about 5 rpm and about 40 rpm, contacting the substrate with the polishing pad at a contact pressure of between about 0.1 psi and about 1 psi, and applying a bias between the substrate and an electrode between about 0.01 watts/cm² and about 40 watts/cm².

14. The method of claim 9, wherein the conductive material comprises copper and the barrier material comprises tantalum, tantalum nitride, or combinations thereof.

15. A method of processing a substrate having a barrier layer and a conductive material layer formed on the barrier layer, comprising:
disposing a substrate in an apparatus comprising a first electrode and a second electrode, wherein the substrate is in electrical contact with the second electrode;
providing an polishing composition between the first electrode and the substrate;
applying a bias between the first electrode and the second electrode;
providing relative motion between the substrate and the polishing article;
pulsing the amount of abrasive in the composition; and
removing conductive layer material and barrier layer material from the substrate.

16. The method of claim 15, wherein the pulsing the amount of abrasive in the composition comprises an abrasive particle concentration between about 2 wt. % and about 4 wt. % of the composition.

17. The method of claim 15, wherein the pulsing the amount of abrasives comprises one or more pulses of a first abrasive particle concentration and a second abrasive particle concentration, and the second abrasive concentration is greater than the first abrasive concentration.

18. The method of claim 17, wherein the first abrasive particle concentration comprises up to 0.4 wt. % of the composition and the second abrasive particle concentration comprises from greater than 0.4 wt. % to about 4 wt. % of the composition.

19. The method of claim 15, wherein the bias is applied to the substrate to initiate an anodic dissolution at a current density between about 0.01 milliamps/cm² and about 100 milliamps/cm².

20. The method of claim 15, wherein the providing relative motion between the substrate and the polishing article comprises providing a substrate to a carrier head at a carrier head rotation speed between about 7 rpm and about 100 rpm, providing a platen having a polishing pad thereon and having a platen rotational speed of between about 5 rpm and about 40 rpm, and contacting the substrate with the polishing pad at a contact pressure of between about 0.01 psi and about 2 psi.

21. The method of claim 18, wherein the pressure applied between the substrate and pad is between about 0.1 psi and about 0.5 psi.

22. The method of claim 15, wherein the abrasive particles comprise inorganic abrasives, polymeric abrasives, polymeric coated abrasives, or combinations thereof.

23. The method of claim 15, wherein the conductive layer material comprises copper and the barrier layer material comprises tantalum, tantalum nitride, or combinations thereof.
